(19) United States
(12) Patent Application Publication
(10) Pub. No.: US 2014/0020516 A1
(43) Pub. Date: Jan. 23, 2014

(54) AIR RATCHET WRENCH

(71) Applicant: Basso Industry Corp., Taichung (TW)

(72) Inventors: Chien-An Liu, Taichung (TW); Chun-Chi Lai, Taichung (TW)

(21) Appl. No.: 13/939,712

(22) Filed: Jul. 11, 2013

(30) Foreign Application Priority Data
Jul. 17, 2012 (TW) 101125610

(51) Int. Cl. B25B 21/00

(52) U.S. Cl. CPC B25B 21/004
USPC 81/57.39

(57) ABSTRACT

An air ratchet wrench includes a wrench body, a rotary driving head, an airflow unit formed in the wrench body, a switch unit, a driving unit and a valve assembly. The airflow unit includes a primary air path and a pair of head-directing paths. When the driving unit is triggered, airflow is permitted to enter the primary air path for driving rotation of the driving head, and is prevented from entering any of the head-directing paths. When the driving unit is not triggered, airflow is prevented from entering the primary air path, and is allowed by the valve assembly to enter one of the head-directing paths selected through user operation of the switch unit for controlling rotation direction of the driving head.

### CROSS-REFERENCE TO RELATED APPLICATION

This application claims priority to Taiwanese Application No. 101125610, filed on Jul. 17, 2012.

### BACKGROUND OF THE INVENTION

1. Field of the Invention

The invention relates to a ratchet wrench, and more particularly to an air ratchet wrench.

2. Description of the Related Art

Referring to FIGS. 1 and 2, U.S. Pat. No. 6,640,669 discloses an air ratchet wrench 1 that includes a wrench body 11, a driving head 12 rotatably extending out of the wrench body 11, a ratchet assembly 13 acting on the driving head 12, a pair of racks 14 respectively and movably disposed at two sides of the ratchet assembly 13, a pair of push buttons 15 (only one is shown in FIG. 2) slidably disposed on the wrench body 11 for respectively moving the racks 14, an air motor assembly 16 and a valve assembly 17. The wrench body 11 is formed with an air-feeding path 111 for connection with an air source (not shown). The ratchet assembly 13 includes a bush 131 geared to the driving head 12, a pawl 132 engageable with the driving head 12 at two positions for controlling rotation direction of the driving head 12, and a gear 133 connected with the pawl 132 and engageable with the racks 14. The air motor assembly 16 includes an air motor 161 in fluid communication with the air-feeding path 111 and a yoke 162 driven by the air motor 161 for reciprocatively rotating the bush 131. The valve assembly 17 includes an open-close valve 171 openably closing the communication between the air-feeding path 111 and the air motor 161, and a trigger 172 pivotally disposed on the wrench body 11 for controlling the open-close valve 171.

By pushing one of the push buttons 15, the corresponding rack 14 drives rotation of the gear 133 to a corresponding position to cause the pawl 132 to change the engagement position thereof with the driving head 12, so as to allow the driving head 12 to rotate in a corresponding direction. Therefore, the rotation direction of the driving head 12 can be controlled through operation of the push buttons 15. When the trigger 172 is pressed, the open-close valve 171 is moved to communicate the air-feeding path 111 and the air motor 161, so that the airflow from the air-feeding path 111 drives the air motor 161 so as to drive in turn the bush 131 through the yoke 162, thereby rotating the driving head 12 via the bush 131.

However, when the driving head 12 is being rotated, the user can still push the other push button 15, and the corresponding rack 14 will drive the gear 133 to switch the engagement position of the pawl 132 and the rotation direction of the driving head 12, easily resulting in damage of the aforesaid components, which will affect adversely smoothness of operation and shorten service life.

### SUMMARY OF THE INVENTION

Therefore, an object of the present invention is to provide an air ratchet wrench that promotes smoothness of operation and has a relatively long service life.

According to the present invention, an air ratchet wrench comprises:

a wrench body;

an action unit including a driving head that is pivoted on the wrench body, and that is rotatable about an axis transverse to a longitudinal direction of the wrench body;

an airflow unit formed in the wrench body, and including an air-feeding path, a primary air path in fluid communication with the air-feeding path, a secondary air path in fluid communication with the air-feeding path, and a pair of head-directing paths each in fluid communication with the secondary air path;

a switch unit operable to allow airflow from the secondary air path to a selected one of the head-directing paths for controlling rotation direction of the driving head;

a driving unit including a trigger, and an open-close valve connected to the trigger, the open-close valve being configured to block airflow from the air-feeding path to the primary air path when the trigger is at a non-triggered state, and to permit airflow from the air-feeding path to the primary air path when the trigger is at a triggered state; and

a valve assembly disposed in the secondary air path, and configured to allow airflow from the secondary air path to the selected one of the head-directing paths when the trigger is at the non-triggered state, and to block airflow from the secondary air path to both of the head-directing paths when the trigger is at the triggered state.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of an air ratchet wrench disclosed in U.S. Pat. No. 6,640,669;

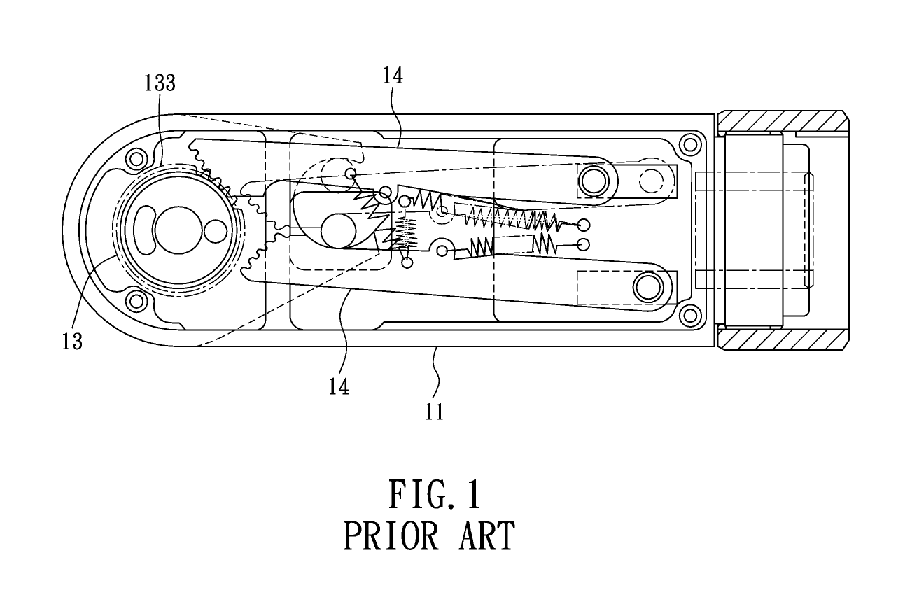

FIG. 2 is a sectional view of the air ratchet wrench disclosed in U.S. Pat. No. 6,640,669;

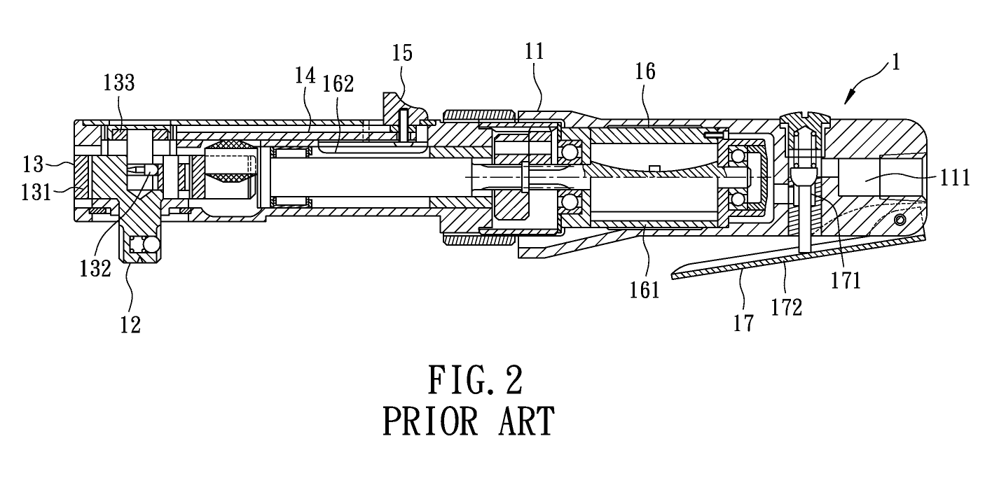

FIG. 3 is a sectional view of a preferred embodiment of an air ratchet wrench according to the present invention;

FIG. 4 is a sectional view of the preferred embodiment taken along line IV-IV in FIG. 3;

FIG. 5 is a sectional view of the preferred embodiment taken along line V-V in FIG. 4;

FIG. 6 is a sectional view showing the preferred embodiment, and illustrating that a secondary air path is opened;

FIG. 7 is a sectional view showing the preferred embodiment with an opened head-directing path, and illustrating how airflow from the secondary air path to a selected head-directing path is allowed;

FIG. 8 is a sectional view of the preferred embodiment taken along line VIII-VIII in FIG. 3;

FIG. 9 is a sectional view showing the preferred embodiment, and illustrating that an air-feeding path and an air-motor are fluidly communicated; and

FIG. 10 is a sectional view showing the preferred embodiment, and illustrating that the secondary air path is closed.

### DETAILED DESCRIPTION OF THE PREFERRED EMBODIMENT

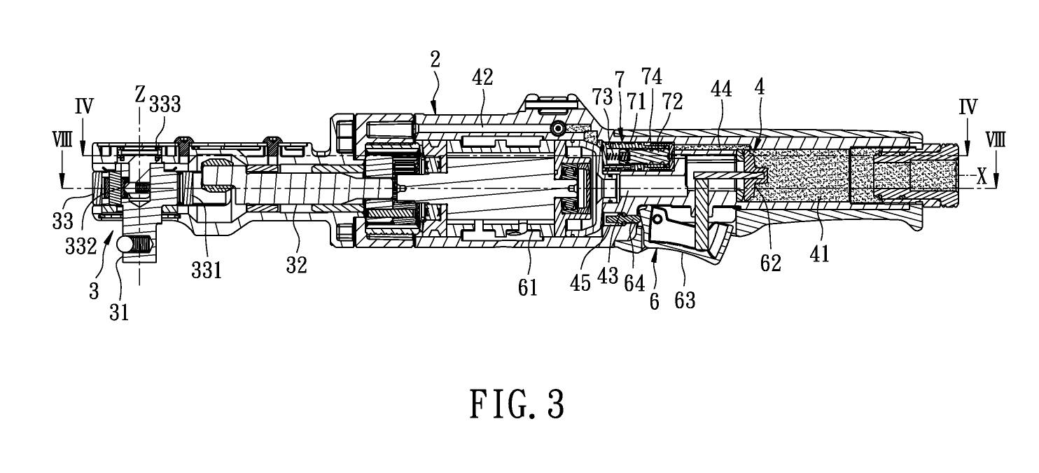

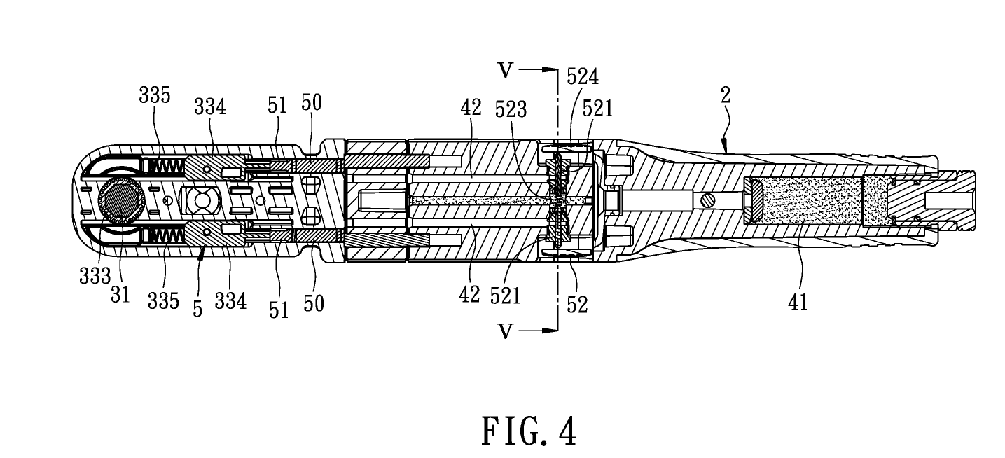

Referring to FIGS. 3 and 4, the preferred embodiment of the air ratchet wrench according to this invention is shown to include a wrench body 2, an action unit 3, an airflow unit 4, a switch unit 5, a driving unit 6 and a valve assembly 7.

The action unit 3 includes a driving head 31 that is pivoted on a front end portion of the wrench body 2, and that is rotatable about a Z-axis transverse to a longitudinal direction of the wrench body 2, a transmission mechanism 33 for driving rotation of the driving head 31, and a connection mechanism 32 connected to the transmission mechanism 33. The transmission mechanism 33 includes a yoke 331 engaged with the driving head 31, a pawl 332 engaged with the driving head 31 and controlling rotation direction of the driving head 31, a reverse gear 333 connected to the pawl 332, a pair of racks 334 that extend in an X-axis direction (i.e., the longitudinal direction of the wrench body 2), and that are respectively and movably disposed at two sides of the reverse gear 333, and a pair of springs 335. Each of the racks 334 is engageable with the reverse gear 333. The springs 335 respectively bias the racks 334 to disengage the reverse gear 333.

The airflow unit 4 is formed in the wrench body 2, and includes an air-feeding path 41 proximate to a rear end portion of the wrench body 2, a primary air path 43 in fluid communication with the air-feeding path 41, a secondary air path 44 in fluid communication with the air-feeding path 43, a pair of head-directing paths 42 each in fluid communication with the secondary air path 44, and an air-discharging path 45 for permitting air to flow out of the air ratchet wrench therethrough. Both of the air-feeding path 41 and the primary air path 43 extend in the X-axis direction.

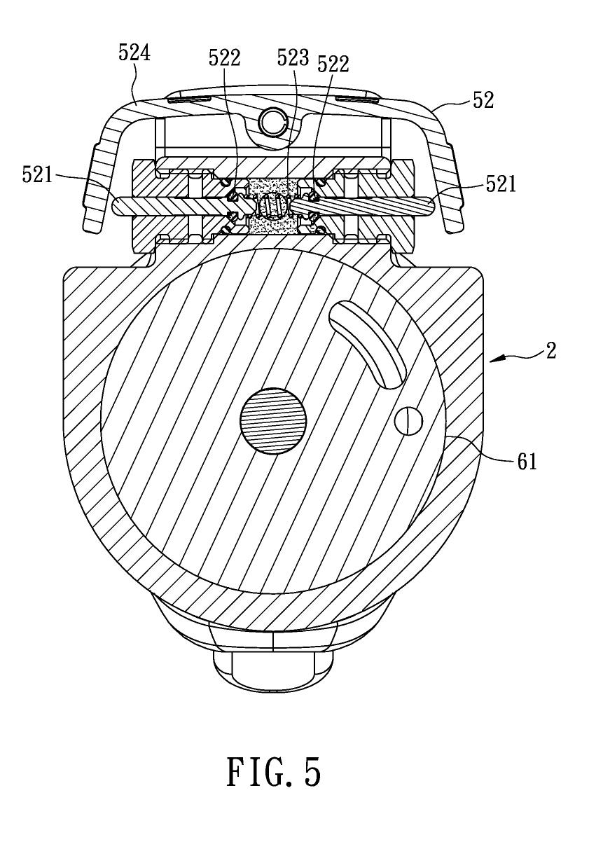

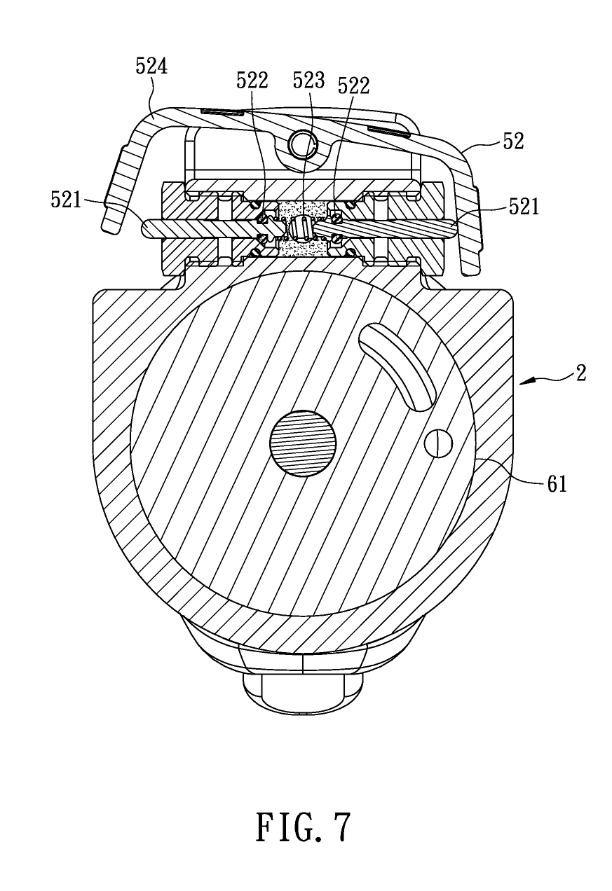

The switch unit 5 includes a pair of chambers 50 in fluid communication with the head-directing paths 42, respectively, a pair of first plug components 51 respectively, movably and sealingly disposed in the chambers 50, and a valve plug assembly 52 disposed between the secondary air path 44 and the head-directing paths 42. The first plug components 51 are respectively connected to the racks 334 of the transmission mechanism 33. Further referring to FIG. 5, the valve plug assembly 52 includes a pair of second plug components 521 each extending in the wrench body 2, a pair of seal components 522 sleeved respectively on the second plug components 521, a first resilient component 523 with two opposite ends respectively abutting against the second plug components 521, and a seesaw component 524 pivoted on the wrench body 2 and configured to abut against a selected one of the second plug components 521, so as to be operable by a user to apply an external force to the selected one of the second plug components 521. Each of the second plug components 521 is movable, by the external force from the seesaw component 524 and a resilient force of the first resilient component 523, between a blocking position at which airflow from the secondary air path 44 to a corresponding one of the head-directing paths 42 is prevented (see FIG. 5), and a communicating position at which the airflow from the secondary air path 44 to the corresponding one of the head-directing paths 42 is allowed (see FIG. 7). The valve plug assembly 52 is thus operable by the external force from the user to allow the airflow from the secondary air path 44 to one of the head-directing paths 42, so as to move the corresponding one of the first plug components 51 to drive the transmission mechanism 33 for rotating the driving head 31 in a corresponding direction.

The driving unit 6 includes an air motor 61, an open-close valve 62, a trigger 63 connected to the open-close valve 62, and a valve plug 64. The open-close valve 62 prevents airflow from the air-feeding path 41 to the primary air path 43 when the trigger 63 is at a non-triggered state, so that the air flows from the air-feeding path 41 into only the secondary air path 44. The open-close valve 62 permits airflow from the air-feeding path 41 to the primary air path 43 when the trigger 63 is operated to move the open-close valve 62, so that the air flows into the primary air path 43 and the secondary air path 44. The valve plug 64 closes the air-discharging path 45 when the trigger 63 is at the non-triggered state, and can be moved by the trigger 63 to permit air to flow out of the air ratchet wrench through the air-discharging path 45.

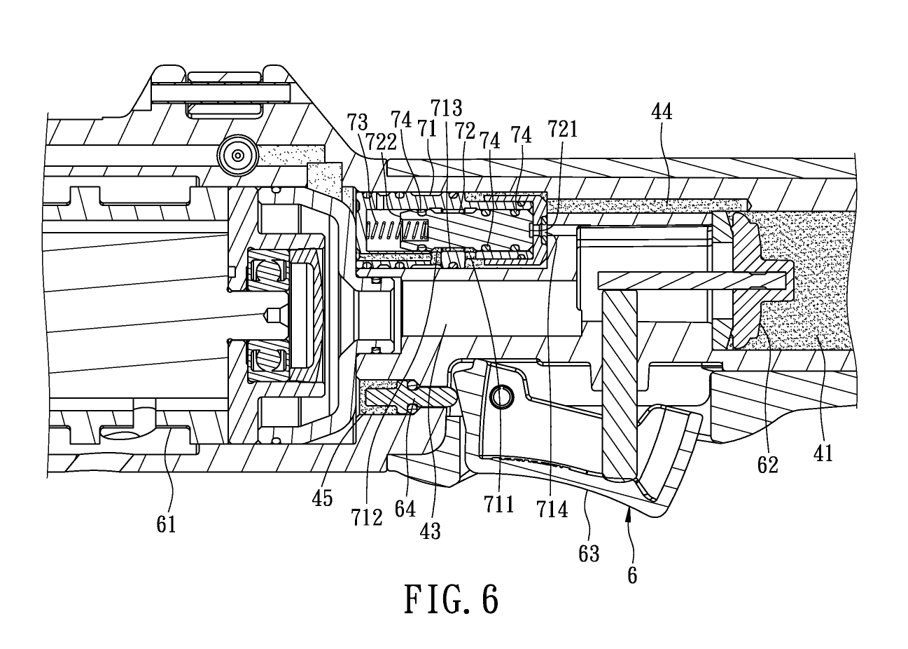

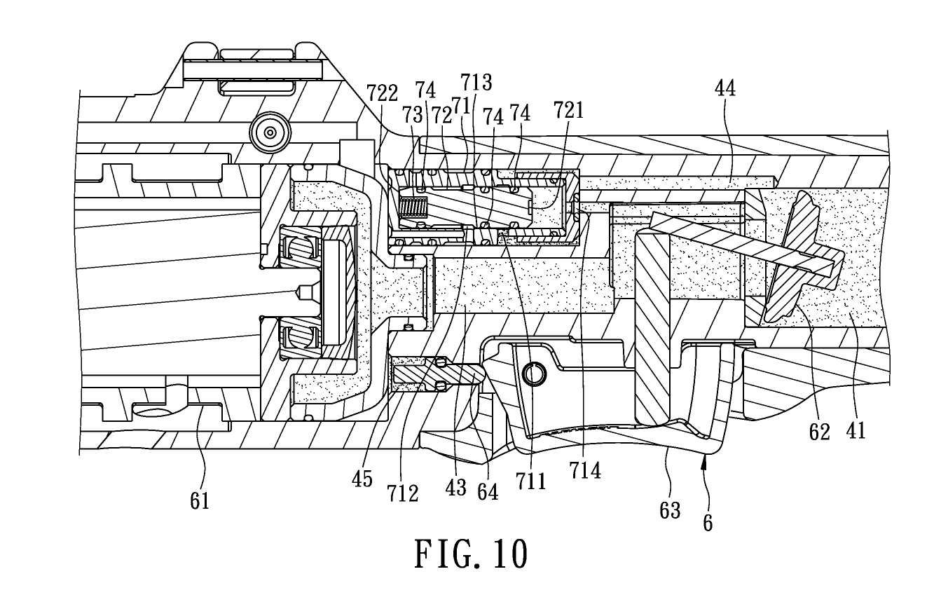

Referring to FIGS. 3 and 6, the valve assembly 7 includes a valve sleeve 71 disposed in the secondary air path 44, a valve component 72 disposed in the valve sleeve 71, a second resilient component 73, and several seal components 74 sleeved on the valve component 72. The valve sleeve 71 is formed with a first air-entering port 711 in fluid communication with the secondary air path 44, an air-exiting port 712 that is in fluid communication with the air-discharging path 45 and that is for guiding airflow from the first air-entering port 711 to the selected one of the head-directing paths 42 therethrough, a separator 713 disposed between the first air-entering port 711 and the air-exiting port 712, and a second air-entering port 714 fluidly communicating an internal space of the valve sleeve 71 and the primary air path 43. The valve component 72 has a first end surface 721 facing the second air-entering port 714, and a second end surface 722 opposite to the first end surface 721. The second resilient component 73 is disposed between the second end surface 722 of the valve component 72 and the valve sleeve 71. The seal components 74 sealingly contact the valve sleeve 71. The valve component 72 is movable between a first position at which one of the seal components 74 does not contact the separator 713 so that airflow from the secondary air path 44 to the selected one of the head-directing paths 42 is allowed (see FIG. 6), and a second position at which the one of the seal components 74 sealingly contacts the separator 713 so that airflow from the secondary air path 44 to both of the head-directing paths 42 is prevented (see FIG. 10).

Referring to FIGS. 3, 4 and 6, when the trigger 63 is at the non-triggered state, the open-close valve 62 closes the air-feeding path 41 to prevent airflow into the primary air path 43 and the air motor 61. At this state, since there is no airflow acting on the valve component 72, the valve component 72 is biased by the second resilient component 73 to the first position, so that the air enters the valve sleeve 71 from the secondary air path 44 through the first air-entering port 711 of the valve sleeve 71, and returns to the secondary air path 44 through the air-exiting port 712. However, the airflow toward the head-directing paths 42 is stopped by the valve plug assembly 52.

As such, since no air enters either of the head-directing paths 42, the first plug components 51 are not moved and the racks 334 are still respectively separated from the reverse gear 333.

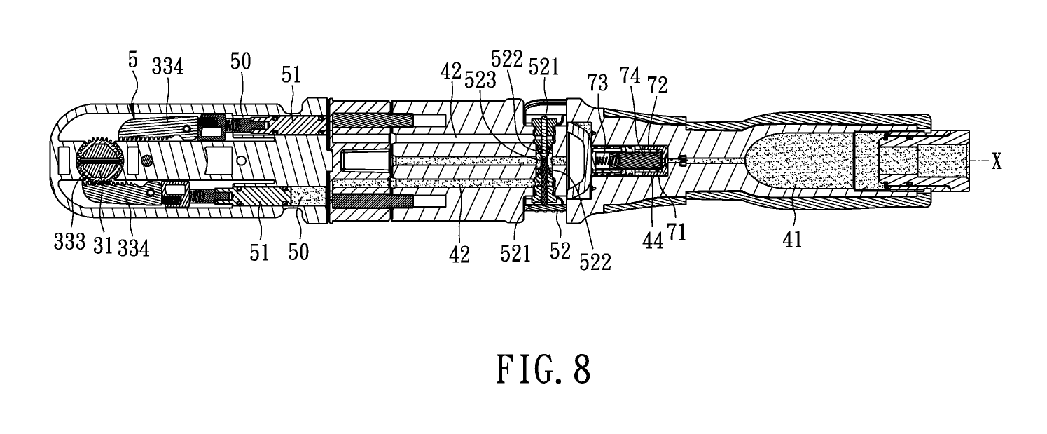

Referring to FIGS. 7 and 8, when one end of the seesaw component 524 is forced by the user (e.g., using a thumb), one of the second plug components 521 is moved to the communicating position, so as to allow airflow from the secondary air path 44 to the selected one of the head-directing paths 42 through the first air-entering port 711 and the air-exiting port 712. Hence, the airflow pushes one of the first plug components 51 and overcomes a resilient force of the corresponding spring 335 for moving the corresponding rack 334 toward the reverse gear 333, thereby rotating the reverse gear 333 to change the engagement position between the pawl 332 and the driving head 31, so that the driving head 31 can only rotate in the corresponding direction. The switch unit 5 thus controls rotation direction of the driving head 31.

At this time, since the airflow from the air-feeding path 41 to the air motor 61 is still prevented, the driving head 31 is not rotated.

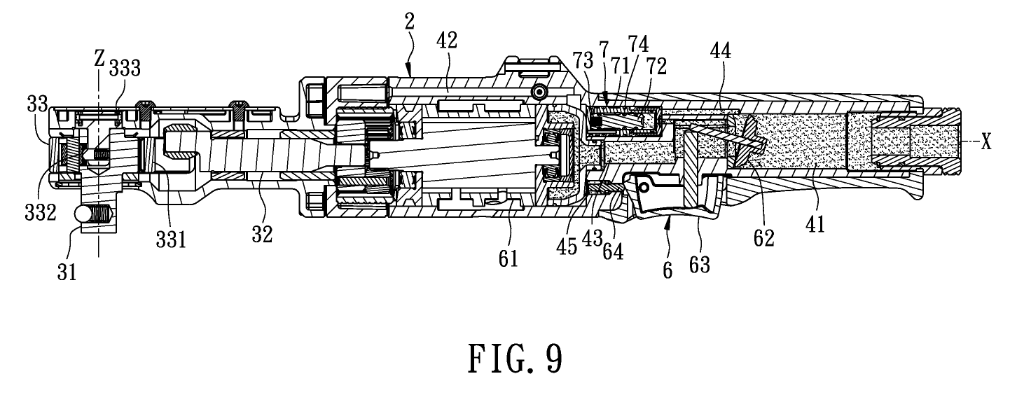

Referring to FIGS. 9 and 10, when the trigger 63 is at the triggered state, the open-close valve 62 opens the air-feeding path 41 to allow the air to enter the secondary air path 44 and the primary air path 43, and the valve plug 64 is forced by the trigger 63 to open the air-discharging path 45.

At this time, the air flows from the primary air path into the valve sleeve 71 through the second air-entering port 714 and applies a pushing force on the first end surface 721 of the valve component 72 to overcome a resilient force of the second resilient component 73, so that the valve component 72 is moved to the second position. The seal component 74 that sealingly contacts the separator 713 thus stops passage of the airflow through the valve sleeve 71, so as to block the airflow from the secondary air path 44 to both of the head-directing paths 42, and the air flows out of the air ratchet wrench through the air-exiting port 712 and the air-discharging path 45. Since flow of the air into any one of the head-directing paths 42 is prevented, rotation direction of the driving head 31 cannot be switched.

At this time, the air flows from the primary air path 43 into the air motor 61, and thus drives the air motor 61 to swing the yoke 311 about the Z-axis direction through the connection mechanism 32, so as to rotate the driving head 31 in a single direction.

To sum up, when using the air ratchet wrench according to this invention, rotation direction of the driving head 31 can be switched by simply pressing the seesaw component 524 when the trigger 63 is not operated. When the trigger 63 is operated to drive rotation of the driving head 31, the airflow is interrupted such that the rotation direction cannot be switched, so as to prevent damage of the aforesaid components, and to promote smoothness of operation and service life.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An air ratchet wrench comprising:
a wrench body;
an action unit including a driving head that is pivoted on said wrench body, and that is rotatable about an axis transverse to a longitudinal direction of said wrench body;
an airflow unit formed in said wrench body, and including an air-feeding path, a primary air path in fluid communication with said air-feeding path, a secondary air path in fluid communication with said air-feeding path, and a pair of head-directing paths each in fluid communication with said secondary air path;
a switch unit operable to allow airflow from said secondary air path to a selected one of said head-directing paths for controlling rotation direction of said driving head;
a driving unit including a trigger, and an open-close valve connected to said trigger, said open-close valve being configured to block airflow from said air-feeding path to said primary air path when said trigger is at a non-triggered state, and to permit airflow from said air-feeding path to said primary air path when said trigger is at a triggered state; and
a valve assembly disposed in said secondary air path, and configured to allow airflow from said secondary air path to the selected one of said head-directing paths when said trigger is at the non-triggered state, and to block airflow from said secondary air path to both of said head-directing paths when said trigger is at the triggered state.

2. The air ratchet wrench as claimed in claim 1, wherein each of said air-feeding path, said primary air path and said secondary air path extends along the longitudinal direction of said wrench body.

3. The air ratchet wrench as claimed in claim 1, wherein said valve assembly includes:
a valve sleeve disposed in said secondary air path, and having an internal space in fluid communication with said primary air path; and
a valve component disposed in said valve sleeve, and movable between a first position at which airflow from said secondary air path to the selected one of said head-directing paths is allowed, and a second position at which airflow from said secondary air path to both of said head-directing paths is prevented;
said valve assembly being configured such that said valve component is at the first position when said trigger is at the non-triggered state, and at the second position due to airflow from said primary air path when said trigger is at the triggered state.

4. The air ratchet wrench as claimed in claim 3, wherein said valve assembly further includes at least one seal component sleeved on said valve component and sealingly contacting said valve sleeve, said valve sleeve being formed with a first air-entering port in fluid communication with said secondary air path, an air-exiting port for guiding airflow from said first air-entering port to the selected one of said head-directing paths therethrough, a separator disposed between said first air-entering port and said air-exiting port, and a second air-entering port fluidly communicating said internal space and said primary air path;
wherein said seal component does not contact said separator when said valve component is at the first position, so that the valve assembly allows airflow from said secondary air path to the selected one of said head-directing paths through said first air-entering port and said air-exiting port; and
wherein said seal component sealingly contacts said separator when said valve component is at the second position, so as to block the airflow from said secondary air path to both of said head-directing paths.

5. The air ratchet wrench as claimed in claim 4, wherein said airflow unit further includes an air-discharging path in fluid communication with said air-exiting port for permitting air to flow from said air-exiting port out of said air ratchet wrench, said driving unit further including a valve plug that closes said air-discharging path when said trigger is at the non-triggered state, and that is moved by said trigger to permit air to flow out of said air ratchet wrench through said air-discharging path.

6. The air ratchet wrench as claimed in claim 4, wherein said valve component has a first end surface facing said second air-entering port, and a second end surface opposite to said first end surface, said valve assembly further including a resilient component disposed between said second end surface of said valve component and said valve sleeve, so as to bias said valve component to the first position when said trigger is at the non-triggered state.

7. The air ratchet wrench as claimed in claim 1, wherein said action unit further has a transmission mechanism for driving rotation of said driving head, said switch unit including:
a pair of chambers in fluid communication with said head-directing paths, respectively;
a pair of first plug components connected to said transmission mechanism, and disposed movably and sealingly in said chambers, respectively; and
a valve plug assembly disposed between said secondary air path and said head-directing paths;
wherein said valve plug assembly is operable by an external force to selectively allow the airflow from said secondary air path to one of said head-directing paths, so as to move the corresponding one of said first plug components to drive said transmission mechanism for rotating said driving head in a corresponding direction.

8. The air ratchet wrench as claimed in claim 7, wherein said valve plug assembly includes:
a pair of second plug components each extending in said wrench body and movable to control airflow from said secondary air path to a respective one of said head-directing paths;
a pair of seal components sleeved on said second plug components, respectively; and
a resilient component with two opposite ends abutting against said second plug components, respectively;
each of said second plug components being movable, by the external force and a resilient force of said resilient component, between a blocking position at which airflow from said secondary air path to a corresponding one of said head-directing paths is prevented, and a communicating position at which the airflow from said secondary air path to the corresponding one of said head-directing paths is allowed.

9. The air ratchet wrench as claimed in claim 8, wherein said valve plug assembly further includes a seesaw component pivoted on said wrench body and configured to abut against a selected one of said second plug components, so as to apply the external force to the selected one of said second plug components.
